(19) United States
(12) Patent Application Publication
(10) Pub. No.: US 2011/0178793 A1
(43) Pub. Date: Jul. 21, 2011

(54) DIALOGUE ANALYZER CONFIGURED TO IDENTIFY PREDATORY BEHAVIOR

(76) Inventors: David Lee Giffin, Winston-Salem, NC (US); Robert Thomas McClung, Conroe, TX (US); Jason Scott Stirman, The Woodlands, TX (US); Brandon LaBranche Watson, The Woodlands, TX (US)

(21) Appl. No.: 13/009,750

(22) Filed: Jan. 19, 2011

Related U.S. Application Data
(63) Continuation of application No. 11/864,700, filed on Sep. 28, 2007, now abandoned.

(51) Int. Cl. G06F 17/27

(52) U.S. Cl. 704/9

(57) ABSTRACT

A dialogue analyzer configured to identify online communications relating to lewd, predatory, hostile, and/or otherwise inappropriate subject matter is disclosed. Identified communications include those occurring via social networks, instant messaging, online chat rooms, computer in-game chat, email and the like. The communications of a monitored computer user are scanned to identify those communications that match predetermined lexical rules. The rules comprise sets of word-concepts that may be associated based on spelling, sound, meaning, appearance or probability of appearance in a text string, etc. Various numbers and configurations of word concepts may be implemented in a rule in order to more accurately scan the online communication data for a potential match. When a match is found, a copy of the communication, along with contextual information, is presented to a parent or guardian user. This information is presented at a central website and via an email notification to the parent or guardian. Various embodiments are described.

### FIELD OF THE DISCLOSURE

The present disclosure relates to a system and method for monitoring and analyzing communications.

### BACKGROUND OF THE DISCLOSURE

Electronic interaction over computer networks is a ubiquitous form of communication in our current society. Millions of users communicate through online services with each other while at work, at school, or at home. These services include instant messaging services (such as AIM, Yahoo, MSN, etc.) that provide the ability to engage in real-time communications with other users, social network services (such as MySpace®, Facebook, Bebo, etc.) that allow users to post notes and messages on virtual profiles of one another, and other similar services (such as chat room services). Continual advances in the technology relating to these services have made them preferred forms of communication. This is especially true amongst minors (i.e., under 18 years old).

But although online instant messaging services and social networks deliver many benefits, they also present certain risks. In fact, some research shows that one out of every seventeen minors has been threatened or harassed online; and one out of every five U.S. teens who regularly log on to the internet have received a sexual solicitation or approach over the internet. These statistics are disturbing to many parents and guardians, especially given the fact that only twenty five percent of children will tell a parent or guardian about an online encounter with a predator. With the increasing popularity of social networks and instant messaging, there is an increasing risk that more children will be subjected to inappropriate and/or dangerous behavior online.

Many of the methods currently available to deal with this problem are ineffective and cumbersome to administer. For example, most current methods involve keyword-based detection systems, which by their very nature are limited to the detection of a set of particular words. Moreover, keyword-detection struggles to accurately monitor inappropriate communications that contain misspellings, slang, leet language (where combinations of alphanumerics are used to replace proper letters and spelling, such as “pr0n,” which is leet for pornography), instant messaging acronyms, a fast changing vocabulary, or any other expression that does not contain a previously stored keyword. These systems also require an enormous amount of parental administration, such the constant updating of libraries of keywords by a parent or guardian. The burden of administering these systems may cause many parents or guardians to avoid monitoring their child's online activity.

The existing methods can also unnecessarily sacrifice the privacy of those monitored. This is because many of these methods require the parent or guardian to read the entirety of a child's conversation in order to find isolated instances of potentially inappropriate communications. This invasion of privacy may also cause many parents or guardians to avoid monitoring online activity altogether.

### SUMMARY OF THE DISCLOSURE

Thus, a need exists for a dialogue analyzer that straightforwardly and accurately identifies inappropriate electronic communications and notifies a parent or guardian of these communications without substantially hindering the monitored user's privacy. Accordingly, one aspect of the present disclosure is to provide a dialogue analyzer that can be configured to straightforwardly identify predatory and/or inappropriate behavior without substantial invasion of the privacy of those monitored. In one embodiment, the dialogue analyzer presents straightforward reports of the predatory and/or inappropriate behavior to a parent or guardian of the child. These reports are substantially limited to the inappropriate dialogue and contextual information. The contextual information may include portions of the conversation that occurred before (or after) the inappropriate dialogue, summaries of the dialogue, pictures, multimedia, links to the inappropriate dialogue, and the like. This system preserves the monitored user's privacy by limiting the amount of the conversation that the parent or guardian is able to read, while also presenting the parent or guardian with contextual text surrounding the inappropriate content in order to make the content easier to understand. In one embodiment, the reports also contain an explanation of why the communication was improper.

Another aspect of the present disclosure includes a method for monitoring electronic communications by using lexical rules based on word concepts in order to more accurately detect behavior that is considered predatory or otherwise inappropriate. These word concepts include expressions that contain not only a given word, but also other words and alphanumeric combinations that are associated with the given word because of like sound, meaning, usage, etc. In this method, a monitored user's communications are copied and transmitted to a threat analysis server, which scans the communications to determine whether any portion of the communication matches a lexical rule. When a match is found, an alert containing the rule-matching conversation is forwarded to an electronic address associated with a parent or guardian of the user.

Yet another aspect of the present disclosure is to provide a system for monitoring a child's electronic communications without unnecessary administration by a parent or guardian. The system employs a central service that administers the detection of inappropriate and/or predatory online behavior. The parent needs only to install or download a client onto any computer device he or she wishes to be monitored. The central service then identifies any communications made between the monitored child and remote users, scans the communications for inappropriate content, and provides notice of the inappropriate content to all system users who are monitoring the child. The central service is also regularly updated by a central administrator in order to improve its detection and notification features.

For purposes of summarizing the disclosure, certain aspects, advantages and novel features of the disclosure have been described herein. Of course, it is to be understood that not necessarily all such aspects, advantages or features will be embodied in any particular embodiment of the disclosure.

### BRIEF DESCRIPTION OF THE DRAWINGS

The following drawings and the associated descriptions are provided to illustrate embodiments of the present disclosure and do not limit the scope of the claims.

FIG. 1 is a diagram of the dialogue analyzer according to an embodiment of the present disclosure.

FIG. 2 is a screen shot of the user interface of the dialogue analyzer system according to an embodiment of the present disclosure.

FIG. 2B is a screen shot of a screen name report and rating survey according to an embodiment of the present disclosure.

FIG. 3 is a screen shot of an instant message alert notification according to an embodiment of the present disclosure.

FIG. 4 is a screen shot of a social network alert notification according to an embodiment of the present disclosure.

FIG. 5 is a depiction of the client architecture according to an embodiment of the present disclosure.

FIG. 6 is a component diagram of a threat analysis server according to an embodiment of the present disclosure.

FIG. 7 is a process flow diagram for an instant message collector according to an embodiment of the present disclosure.

FIG. 8 is a process flow diagram for a note collector according to an embodiment of the present disclosure.

FIG. 9 is a diagram of the instant message scanning process according to an embodiment of the present disclosure.

FIGS. 9A, 9B, and 9C are process flow diagrams for an instant message scanner according to a preferred embodiment of the present disclosure.

FIG. 10 is a diagram of the note scanning process according to an embodiment of the present disclosure.

FIGS. 10A, 10B, and 10C are process flow diagrams for a note scanner according to a preferred embodiment of the present disclosure.

FIG. 11 is a diagram depicting the basic definition of a primitive according to an embodiment of the present disclosure.

FIG. 12 is a diagram depicting the basic definition of a rule according to an embodiment of the present disclosure.

FIG. 13 is a diagram depicting the basic definition of an alert according to an embodiment of the present disclosure.

### DETAILED DESCRIPTION OF THE DISCLOSURE

The following disclosure describes a tool for parents and guardians to monitor the online behavior of their children without substantially invading their privacy. The tool includes a client that is installed on a computer for the purpose of copying certain online communications of a monitored child user. These communications are forwarded to a threat analysis server administered by a central web service, which substantially eliminates the administrative effort required by parents. The threat analysis server scans the communications to determine whether any portion of the communication matches a lexical rule associated with improper content. When a match is found, an alert containing the rule-matching conversation is sent to an electronic address associated with a parent or guardian of the user. The alert is substantially restricted to the inappropriate dialogue along with a limited amount of contextual dialogue, thus preserving the privacy of the child user while also making the content easy to understand. The alert notification can also contain an explanation of why the communication is considered improper. Specific embodiments of the disclosure will now be described with reference to the drawings. These embodiments are intended to illustrate, and not limit, the present disclosures. The scope of the disclosure is defined by the claims.

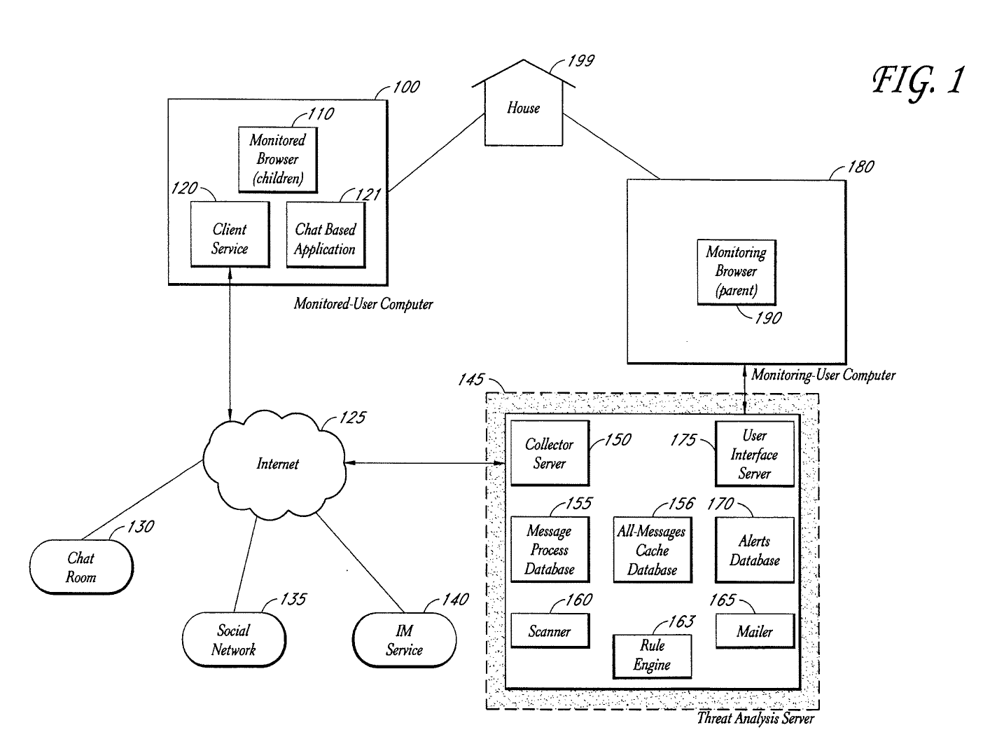

FIG. 1 is a diagram of the dialogue analyzer system according to an embodiment of the present disclosure. The dialogue analyzer system includes a monitored-user computer, threat analysis servers and a monitoring-user computer. The monitored-user computer 100 includes a monitored browser 110, client service 120, and chat-based application 121. In a preferred embodiment, client service 120 is configured as a Windows service, but can also run on OSX, Linux or even a router in other embodiments. The client service 120 comprises software that is downloaded or installed on a monitored-user computer 100. Chat-based application 121 includes a previously installed instant messaging client, social network (browser), or any other application that includes a chat-based component. Threat analysis servers 145 include a collector servers 150, raw messages database 155, all-messages cache database 156, a scanner 160, Rules engine 163, a mailer 165, an alerts database 170, and a user interface server 175. Monitoring-user computer 180 also includes monitoring browser 190. Although monitoring-user computer 180 is described in FIG. 1 as distinct from monitored-user computer 100, these computers may actually be one and the same.

In operation, a local (ie., monitored) user on monitored-user computer 100 communicates via a network connection, such as internet 125, with one or more remote (ie., non-monitored) users via an Instant Messaging Service 140, Social Network 135, Virtual Chat Room 130, or like services, such as a video game service that facilitates text-based chat. Once a communication is received or transmitted by a user of monitored-user computer 100, the previously installed client service 120 receives the communication via the TCP/IP suite, which is the set of communications protocols that implement the protocol stack on which the internet and most commercial networks run. The client service 120 filters the communications it receives and retains data relating to communications between a monitored local user and a remote user of communications services, such as chat rooms, social networks, instant message services, and the like. This data is formatted and delivered to XML/RPC application program interface. The XML/RPC API puts the formatted communication into an HTTP-POST request, the body of which is in XML format. The request is first encrypted and then sent, via internet connection 125, to the threat analysis servers 145 for collection and scanning.

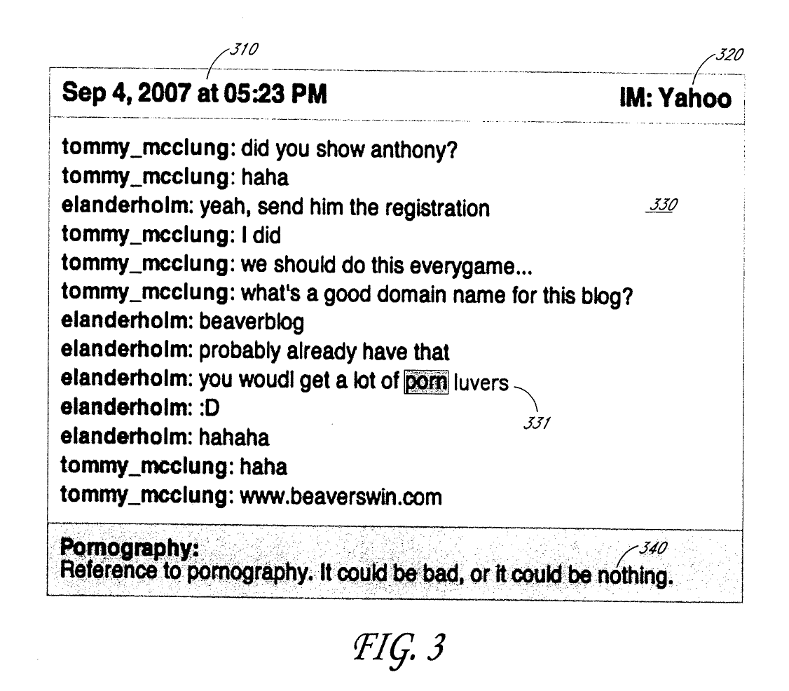

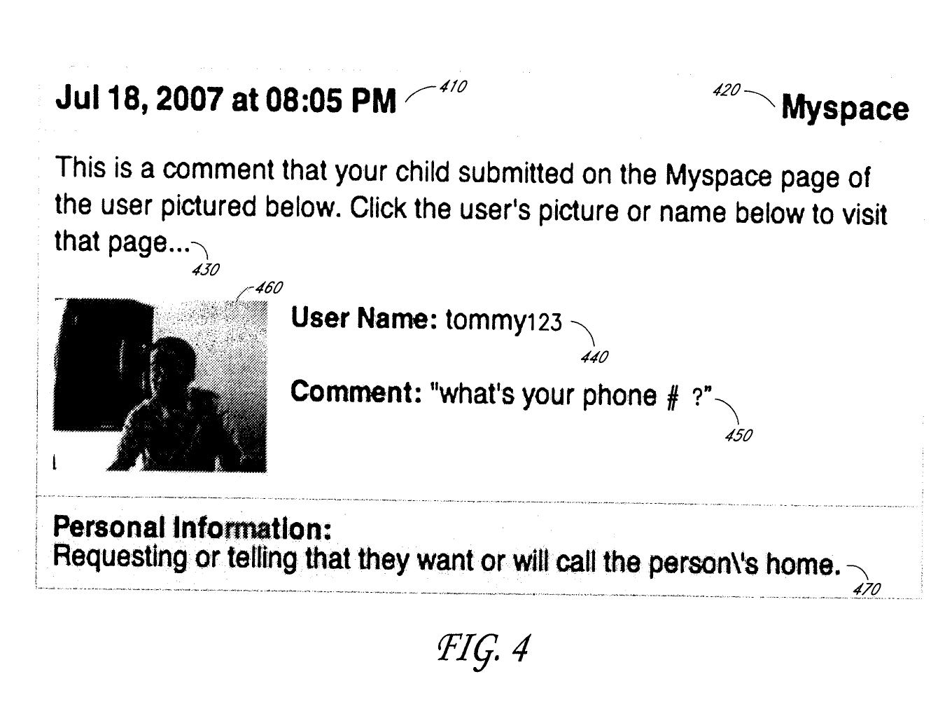

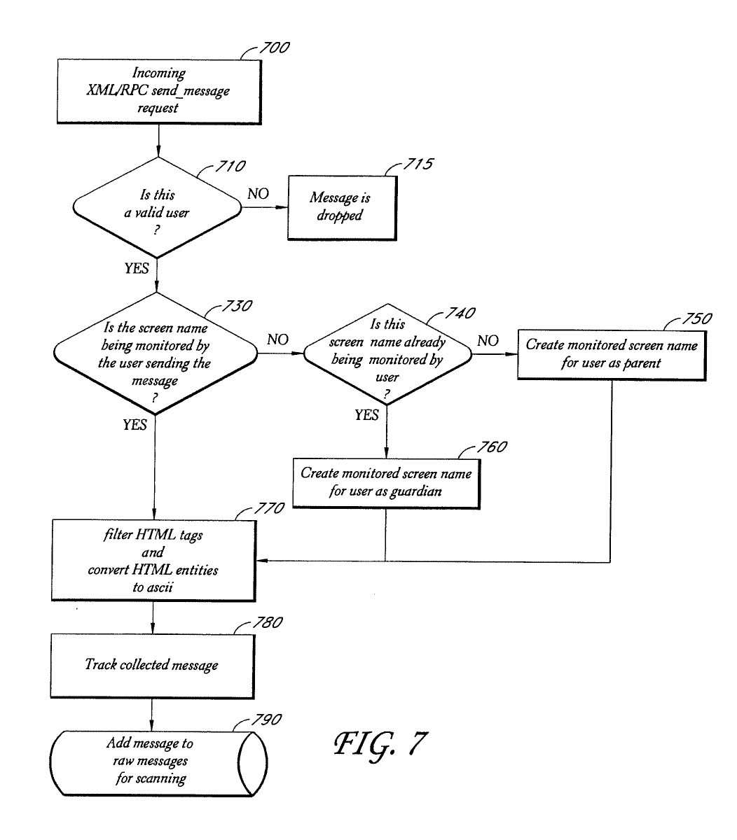

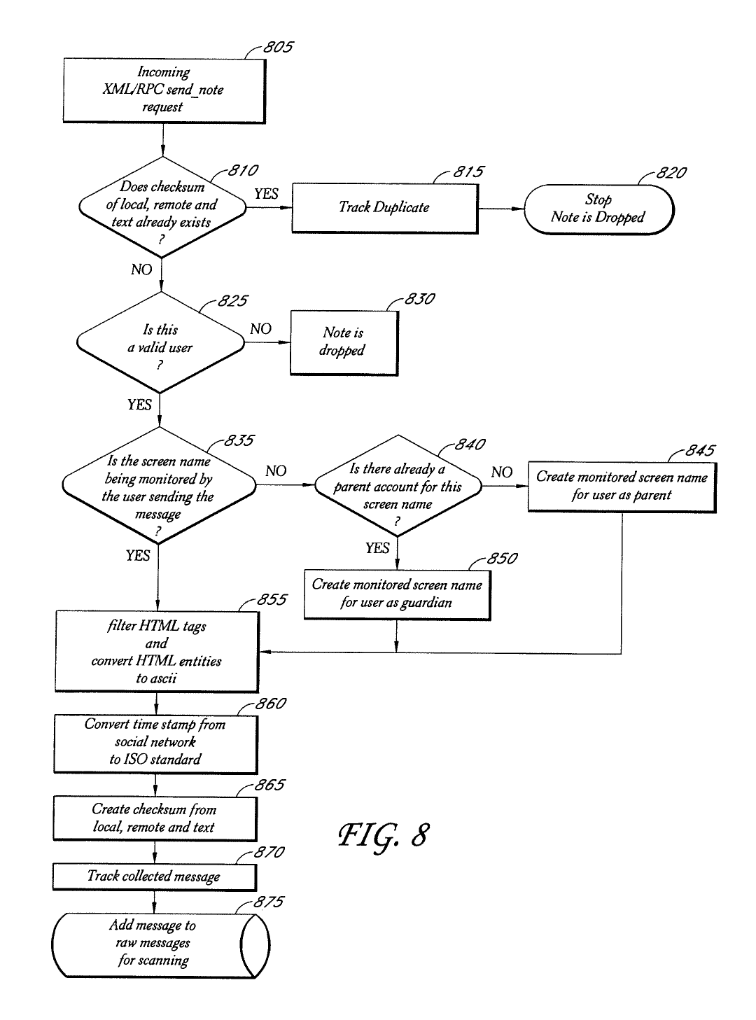

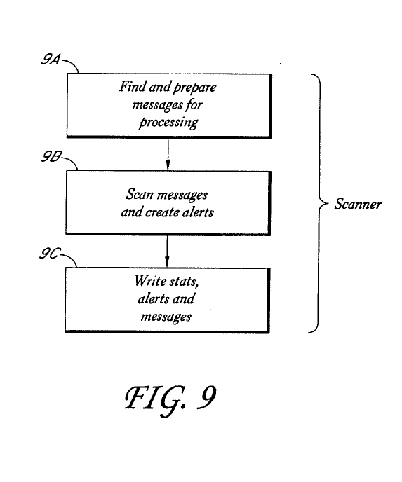

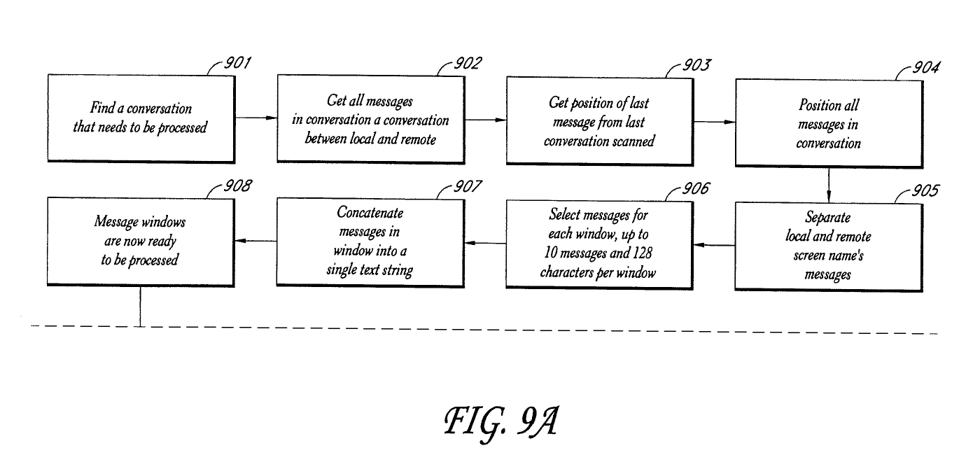

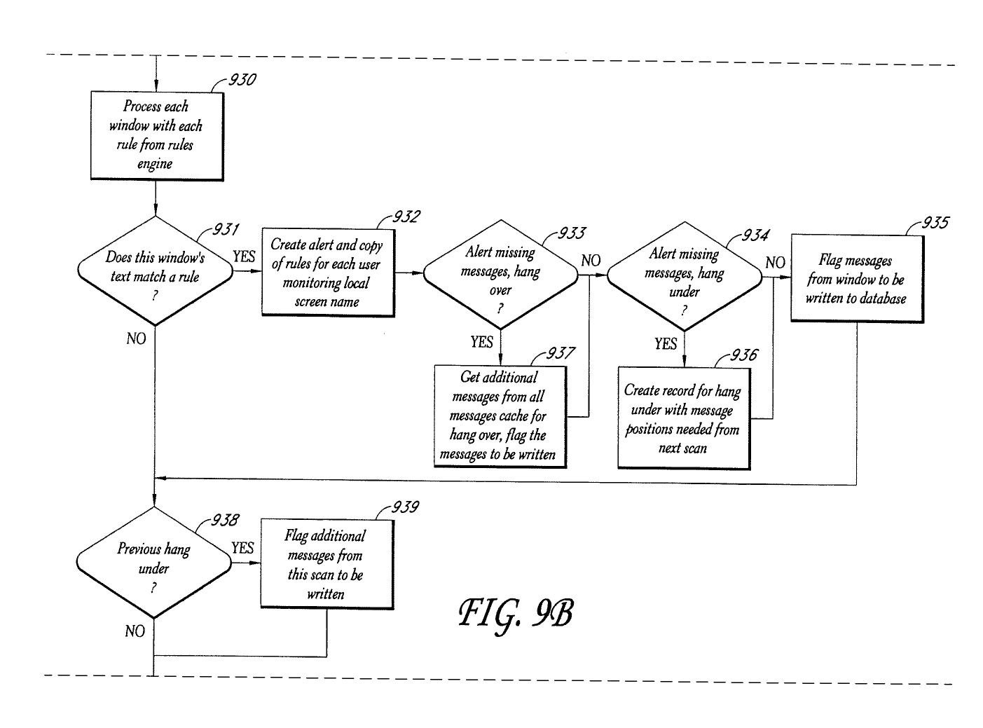

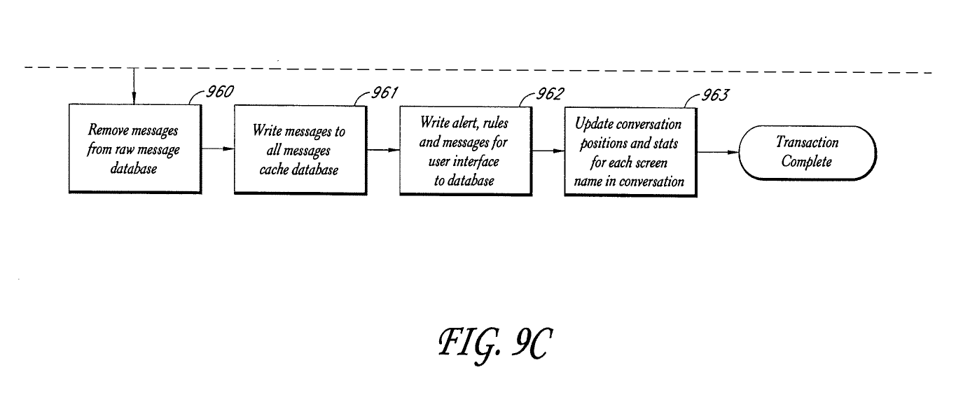

Once the request is received by collector server 150, it is verified through a process explained in greater detail in connection with FIGS. 7 and 8. The processed data is then sent to message process database 155, where it is stored and forwarded to scanner 160. The scanner analyzes the content in order to determine whether any content matches a previously stored rule in Rules Engine 163. These rules, as well as the scanning process, are explained in greater detail with respect to FIGS. 9-12. If a match exists, the content is forwarded to alerts database 170, which is in communication with user interface server 175. The content is forwarded and displayed in the form of an alert notification on monitoring browser 190, which is usually associated with a parent or guardian account in order to notify a parent user that someone has had improper conversations with his or her child. This alert notification includes various details relating to the potentially dangerous communication, as will be explained in greater detail in FIGS. 3 and 4.

In an alternative embodiment, the functionality of collector 150 and scanner 160 may be implemented within client service 120. Likewise, data can be transmitted to the threat analysis servers not only via XML/RPC application, but also in SOAP (Simple Object Access Protocol), CORBA (Common Object Request Broken Architecture), by posting key value pairs, transmitting binary files, and even through a Telnet (ie., non-HTTP) connection. Moreover, instead of monitoring communications over the TCP/IP suite, communications can also be monitored via a serial override PIP (or any other Private Internet Protocol), the UDP (User Datagram Protocol) stack, a human-input device (such as the keyboard), log files, or even a local memory if the communications are first stored and retrieved on local memory. Communications can also be obtained by performing a “screen-scrape” in Windows.

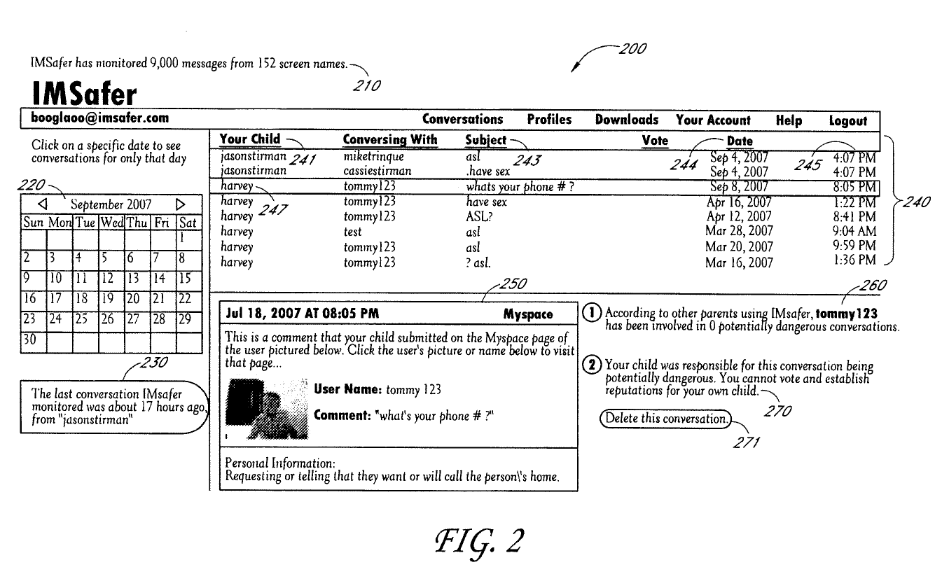

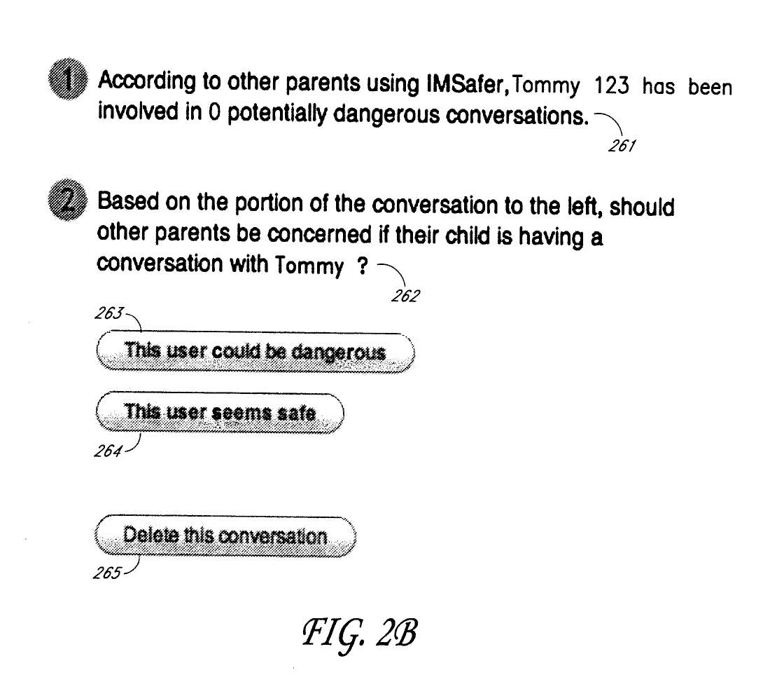

FIG. 2 is a screen shot of the monitoring-user interface 200 according to a preferred embodiment of the present disclosure. It includes community statistics reporting statement 210 that tells the user how many messages the dialogue analyzer service has monitored along with an indication of the number of user screen names (for I.M. or social networking) that have been monitored. In the preferred embodiment, calendar 220 is also posted on the user monitoring-user interface 200. Calendar 220 provides an indication of the number of alerts previously generated by day-of-month based on a log of all alerts that is stored in the alert message database. The user can click on a specific day on the calendar to see the conversations that took place on that day only. Section 230 provides further information identifying the time and local screen name of the last message monitored by the dialogue analyzer service. This information can be gleaned from the data stored in the message process database, as explained earlier with respect to FIGS. 7-10.

User interface 200 further includes alert selection box 240. Alert selection box 240 includes various columns of information corresponding to each alert that has been generated. In the preferred embodiment, the alerts identified in the alert selection box 240 can be sorted by any of the header column titles. These column titles include identifications of (a) the child screen name that was monitored (column 241); (b) the remote screen name participant (column 242); (c) the subject matter of the inappropriate content (column 243); (d) the date the communication took place (column 244); and (e) the time the communication took place (column 245). For example, a user can select line 247, the line is highlighted and information relating to that particular communication is displayed in sections 250, 260 and 270 (explained shortly). Line 247 indicates that the screen name of the child monitored is “harvey,” and the screen name of the remote participant is “Tommy123.” The subject matter of the communication is “what's your phone #” which is a commonly used way of requesting or telling a person that you want or will call the person's home. Line 247 also includes a date corresponding to the date of the communication that led to the generated alert, and a time corresponding to the logout time of the local child screen name. A parent user can select any of the listed alerts for more detailed information regarding the alert, as shown in block 250. Block 250 is a notification of the alert selected from alert selection box 240 (discussed in greater detail in connection with FIG. 4). In an alternative embodiment, different colors are used to indicate which alerts have been read (e.g., blue) and which have not (e.g., yellow). Also, the user interface notification function can be carried out exclusively via text messaging, email messaging, or automated phone calls to access data.

The information displayed in section 260 relates to the number of potentially dangerous conversations that the remote screen name has engaged in. This information is generated based on a vote that each parent can participate in when he or she receives an alert that identifies a remote (non-monitored) screen name participant as the author of a potentially dangerous communication. Paragraph 270 displays different sets of information depending on whether the user's child was responsible for the selected communication or conversation. If a local user's child generated the content responsible for making the selected communication dangerous, then a message will be displayed communicating to the user that he or she cannot vote to establish a reputation for his or her own child. Section 271 gives the user the option of deleting the conversation. One of ordinary skill in the art will appreciate that alternative embodiments of the user interface may include more or less information regarding the communications that were monitored.

However, if a remote (non-monitored) user authored a potentially dangerous communication, then the user is asked to vote on whether the remote screen name could be dangerous, as displayed in FIG. 2B. FIG. 2B is a screen shot of a screen name report and rating survey according to an embodiment of the present disclosure. Question 262 asks each user whether, based on the message identified in the alert, other parents should be concerned if their child is having a conversation with the particular remote screen name identified. The user is given two answer options. Option 263 corresponds to the answer “this user could be dangerous” (or a similar option) and option 274 corresponds to the answer “this user seems safe” (or a similar option). In the preferred embodiment, a parent clicks on the appropriate answer and an identification of the remote screen name is stored in the alert database, along with the number of potentially dangerous conversations that the remote screen name has engaged in. Again, the number of potentially dangerous conversations that a specific screen name has engaged in (in section 261) is based on the number of user-votes corresponding to answer option 263 with respect to that specific remote screen name. In one embodiment, an email notification identifying the potentially dangerous remote screen name is sent to a parent or guardian of the monitored screen name when the number of user-votes corresponding to answer option 263 surpasses a predetermined threshold (e.g., 6). In an alternative embodiment, there may be a non-binary voting system, where users can actually rate how dangerous they believe the identified user may be (on a scale of 1-10, for example).

FIG. 3 is an enlarged view of alert notification 250 for alerts relating to instant messages. In a preferred embodiment, the alert notification includes date and time identification 310, which lists the date and time the communication began. Provider identification 320 identifies the provider of the instant messaging service that was used in the communication (ie., Yahoo!®, MSN, AOL, etc.). Block 330 includes an excerpt of the communication itself. This excerpt includes the specific content deemed inappropriate (line 331 in FIG. 3) according to the rules stored in the Rules Engine in the threat analysis servers. In the example shown, the phrase that has been identified as inappropriate is “you woudl get a lot of porn luvers” (preferably highlighted for easy reading). The excerpt also includes multiple conversation lines that precede (or follow) the inappropriate content in order to give the reader some context to the inappropriate content. Further, in section 340, the alert notification includes a human-readable explanation of why the threat analysis server deemed that the content was inappropriate based on the current rule set. In the example shown, the explanation relates to the use of the phrase “you woudl get a lot of porn luvers,” telling the reader that the phrase is a reference to pornography and that it may be harmful. This explanation (correlated to the use of “porn luvers”) is stored in the alert and message database in the threat analysis servers along with other explanations of slang, shorthand, IM language, and leet speak terminology. These explanations are important because slang, IM short-hand, and leet-language terms are oftentimes difficult to understand, yet frequently used in the communication of inappropriate content online.

In alternative embodiments, the notification may include less information in order to further protect the privacy of the child that is being monitored. In these embodiments, the notification may include only a) the lines of text flagged as inappropriate (with no context); b) an explanation of what type of inappropriate communications took place; c) a summary of the conversation or communication; or d) the names of the parties involved in the communication. Conversely, if privacy is of little or no concern, the notification may provide the text of the entire communication that included inappropriate content.

FIG. 4 is a sample of an alert notification relating to the posting of a comment, note, or any other text-based communication on a social network, such as MySpace®, Bebo, or Facebook. The note/comment alert notification, like the IM alert notification displayed in FIG. 3, includes an identification of (a) the date and time the posting of the note or comment took place in (410); (b) the social network in which the posting took place (420); (c) the display name of the remote user that posted the message (440); (d) the comment flagged by the threat analysis rules engine as inappropriate (450); and (e) a human-readable explanation of why the threat analysis servers deemed that the content was inappropriate based on the current rule set (470).

The note/comment alert notification further displays the profile picture 460 of the monitored local user or the (non-monitored) remote user in the social network. This picture may give a parent further information regarding the remote user, including his sex, age, and overall appearance. A parent or guardian can use this information to determine whether it is desirable for the child to discontinue their communication with a remote user in the social network. Explanatory message 430 is also displayed in the note/comment alert notification. This message explains to the parent user that a comment authored by their child (or left for their child) on a specific social network and that it was used for the communication of the inappropriate content. It also explains how a user's social network profile page can be accessed. In the preferred embodiment, the user name 440 or picture 460 would include a hyperlink to that remote user's profile page.

In alternative embodiments, the note/comment alert notification may include less information in order to further protect the privacy of the child that is being monitored. In these embodiments, the notification may include only a) the lines of text flagged as inappropriate (with no context); b) an explanation of what type of inappropriate communications took place; c) a summary of the conversation or communication; or d) the names of the parties involved in the communication. Conversely, if privacy is of little or no concern, the notification may provide the text of the entire communication that included inappropriate content.

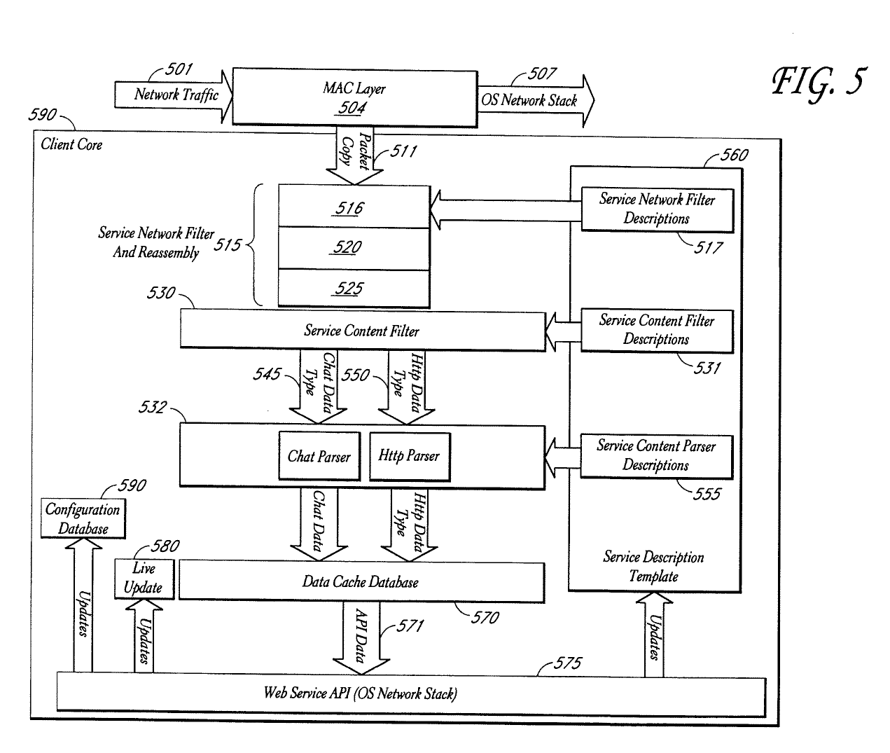

FIG. 5 is a depiction of the Client Service Architecture. The Client core includes a service network packet filter and reassembly module 515, service content filter 530, service content parser 532, Dialogue analyzer service description template 560, Data Cache database 570, and Dialogue analyzer web service API 575. The service network packet filter and reassembly module further includes a service network packet filter 516, TCP Stream reassembly 520, and HTTP stream reassembly 525. The Dialogue analyzer service description template 560 further includes service network filter descriptions database 517, service content filter descriptions database 531, and service content parser descriptions database 555.

In operation, information flows through network traffic 501 to the MAC (Media Access Control) layer 504 in a TCP/IP model. This layer is responsible for moving data packets from the network traffic 501 to the OS Network Stack 507 across a shared channel. Data packets are copied by the client as they pass through the MAC layer 504. These data packets include substantially all communications between a monitored user and a remote screen name. These packet copies 511 are sent to the Service network packet filter and reassembly module 515 for first-level filtering and reassembly.

Service network packet filter 516 performs a first-level filtering of the data in packet copy 511. This data would include various forms of data on any one of a number of service networks, such as instant messages on Yahoo.com, or notes and/or comments transmitted via a social network like MySpace.com. First, the incoming data is converted to a format that includes a computer-readable IP address. Filter 516 then filters the content by creating filter strings that are defined by service network filter descriptions database 517. This database is stored and periodically updated with information relating to the protocol format of various service networks. This protocol format includes a variety of data identifiers, such as TCP service port numbers and/or domain name identifiers. For example, the TCP port used by Yahoo.com in its instant messenger is port 5050. Service network filter descriptions 517 supply the packet filter 516 with this and other information, which the filter uses to identify data that is transmitted via the Yahoo!® instant messaging tool. Alternatively, domain names may also be used to identify desired data. For example, the MySpace® network consists of multiple domain names. However, there are two domain names that typically include comments or notes between users (and therefore may include inappropriate content). The domain names are profile.myspace.com and comments.myspace.com. The service network filter descriptions database contains this and other domain name information, which is then used by the service network packet filter 516 to identify messages on either domain name. After the data packets have been first-level filtered, they are sent to TCP Stream reassembly unit 520 (and then to HTTP stream reassembly unit 525, if necessary) in order to reassemble any out-of-sequence or lost packets that are delivered by the underlying network. This task can be performed by various methods that are known in the art.

Service network filtered and reassembled data is then sent to the service content filter 530, which filters content by data type. In the preferred embodiment, there are multiple data types, including Chat Data 545 and HTTP data 550. Generally, data from social networks comes in the form of HTTP data. In this process, service content filter descriptions 531 are used as parameters that define which content to allow (and which to filter out) by content data type. For example, it is known that online communication data (in the form of notes, comments, and the like) may be exchanged between a local and remote user by posting such data on “profile” pages of social networks. This data, however, is found on a limited number of subpaths in each service. For example, the data posted on profiles on the Facebook social network can be found on www.facebook.com/profile.php. A parameter identifying “/profile.php” as a subpath containing data that should be allowed (i.e., not filtered) is thus supplied by service content filter descriptions 531 to service content filter 530. In the preferred embodiment, these descriptions are periodically updated by the central administrator of the presently disclosed threat analyzer service.

The various data streams are then individually parsed or extracted by data type, using parameters provided by the service content parser descriptions 555. These parameters include a template of regular expressions that define which content is extracted from the incoming data. In an alternative embodiment, however, any one of other well-known methods can be used to parse the data, including pattern matching, URL matching, and extracting data from known offsets. The resulting information is converted into XML/RPC format and then sent to the Data Cache database 570.

Data cache database 570 stores data that is received from parser 532 before it is forwarded to the dialogue analyzer web Service API and eventually ends up in the threat analysis servers. In the preferred embodiment, Data Cache database 570 includes separate caches for notes (transmitted via social-networks) and instant messages (from IM service provider sites). The Data Cache database 570 provides a method for storing data when the threat analysis servers are down or otherwise inoperable. Under this scenario, data is sent to Data Cache database 570, where it is stored until the Servers are operating once again, at which point the data is spooled out into the Web Service API 575. Thus, in the event of server failure, data packets, which are supposed to be sent to the Servers through the web service API 575, are not lost.

Once the data has been parsed and stored in Data cache database 570, XML/RPC application programming interface 571 sends the data to the Dialogue analyzer web service API 575. At this point, the filtered and parsed data is formatted into an XML/RPC request. This request is formatted differently depending on whether it comprises “note” or “comment” data (from social networks) or instant messaging data. This is because alerts relating to instant messages contain less information than alerts relating to a note placed on the profile of a member of a social network. The following table lists the names and types of parameters that are identified and included in a request relating to instant messaging data, along with details regarding the respective significance of each parameter:

TABLE 1.1
Send_Message

| Parameter | Type | Details |
|---|---|---|
| client_id | String | 37 character globally unique identifier, |
| | | associates the client to a threat analyzer |
| | | service account. Only valid threat |
| | | analyzer service generated client |
| | | identifiers are recognized. |
| machine_id | String | Unique identifier for the machine |
| | | on which the client service is installed |
| | | (Windows or OS X) |
| mac | String | The MAC address of the interface that |
| | | captured the IM message |
| client_uuid | String | OS User Name. This is |
| | | the user name of the |
| | | logged in Windows or OS X user. |
| local_screen_name | String | The monitored screen |
| | | name in this message. |
| remote_screen_name | String | The remote screen name |
| | | (not monitored) |
| author | String | The author of the IM message |
| protocol | String | The protocol on which the IM |
| | | message was captured. (ie. MSN, |
| | | Yahoo! ®, AIM, Meebo, |
| | | Myspace ®, etc. . . ) |
| timestamp | String | The timestamp of when this IM |
| | | message was captured. |
| message | String | The body of the IM message. |
| Returns | String | OK, error, or exception message. |
| | | If error or exception message, |
| | | then data is forwarded to |
| | | data cache database for re-analyzing or |
| | | further analysis. |

As shown in Table 1.1, XML/RPC message request includes information pertaining to the client id, the machine (or computer id), the MAC address of the interface that captured the instant message, the operating system user name, the screen names of the local and remote IM users, the author of the instant message, the protocol on which the instant message was captured, a time stamp, and the contents of the instant message itself. The information in the parameters is useful for accurate scanning and notification of inappropriate content, as explained later in FIGS. 9-13.

In contrast, the following table lists the names and types of parameters that are included in the request relating to note data communicated over a social network, along with the respective significance of each parameter:

TABLE 1.2
Send_Note

| Parameter | Type | Details |
|---|---|---|
| client_id | String | 37 character globally unique identifier, |
| | | associates the client to a threat analyzer |
| | | service account. Only valid threat |
| | | analyzer service generated client |
| | | identifiers are recognized. |
| machine_id | String | Unique identifier for the machine |
| | | on which the client service is |
| | | installed (Windows or OS X) |
| mac | String | The MAC address of the interface that |
| | | captured the Note message |
| client_uuid | String | OS User Name. This is the user |
| | | name of the logged in Windows |
| | | or OS X user. |
| local_screen_name | String | The monitored screen name in this note. |
| remote_screen_name | String | The remote screen note (not monitored) |
| author | String | The author of the note message |
| remote_image | String | A Uniform Resource Locator to the |
| | | Image of the remote screen name. |
| protocol | String | The protocol (web service) this |
| | | note was collected on (ie., Myspace ®, |
| | | Facebook, etc,) |
| timestamp | String | The timestamp of when this note |
| | | message was captured. |
| message | String | The body of the note message. |
| details | String | Any details associated with this note. |
| | | For instance the location on the web |
| | | page this note was collected. |
| Returns | String | OK, error, or exception message. |
| | | If error or exception message, then data |
| | | is forwarded to data cache database for |
| | | re-analyzing or further analysis. |

As shown in Table 1.2, the XML/RPC note request contains all the same information as the message request, but also contains information relating to the URL of the image of the remote screen name and any details associated with the note (such as the location on the web page from which the note was collected).

As discussed above, Requests are sent to dialogue analyzer Web Service API 575, where it is then sent to threat analysis servers for data analysis. It is important to note that this data is UTF-8 encoded and thus can support the implementation of languages other than English. Thus, in alternative embodiments, electronic communications in languages other than English can also be analyzed by using lexical rules that are written in that particular language.

The Web Service API 575 also allows for the client to be periodically updated with new service descriptions, updates to its configuration database 590, as well as live updates 580 (which are updates to the core client code). Each of these updates is initiated by the threat analysis servers according to any parameters set by a central administrator of the dialogue/threat analyzer service. Thus, the user of the client does not have to install updates manually, making the use and maintenance of the tool as simple and effortless as possible.

As previously mentioned, in alternative embodiments, the client can also obtain communication data via “screen scraping,” monitoring log files, local disk or memory, or via keyboard logging (or logging any other human input device). An API may also be used whereby third party clients can inject data into the system at the threat analysis server.

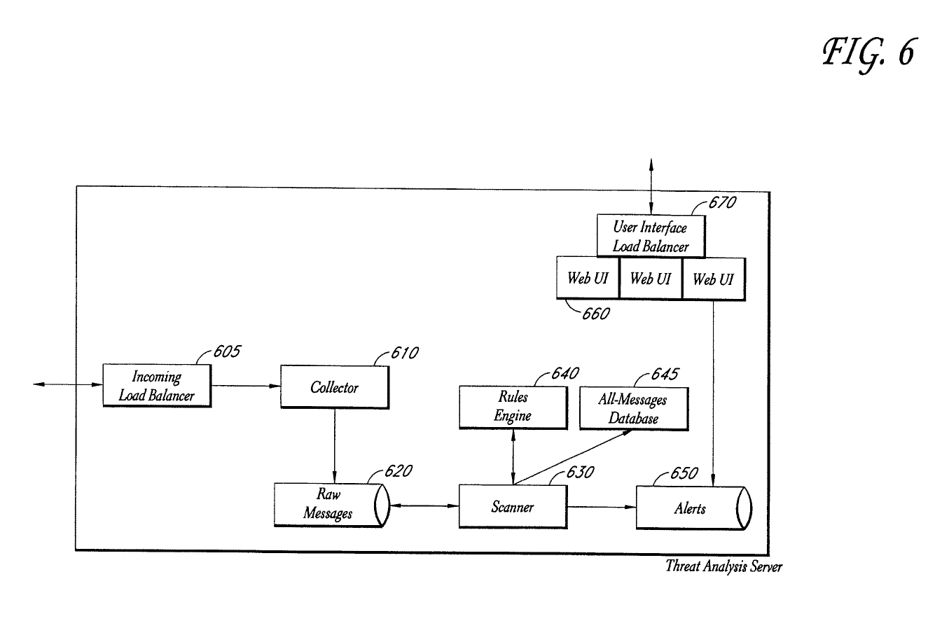

FIG. 6 is a diagram of the components included in the threat analysis server according to a preferred embodiment of the present disclosure. The threat analysis server includes incoming load balancer 605, collector 610, raw messages database 620, scanner 630, rules engine 640, all-messages data cache database 645, alerts database 650, user interfaces 660, and user-interface load balancer 670.

In operation, an XML/RPC request is transmitted via a network connection, such as the internet, and received by the server at incoming load balancer 605, which handles the traffic relating to all incoming requests and increases the scalability of the application. The data is then sent to collector 610. The collector creates parent or guardian screen names for the account associated with the request, converts all HTML entities to ASCII format, and adds the messages to the raw messages database 620 (a process that is discussed in greater detail in connection with FIGS. 7 and 8). The raw messages database stores the message data for access by scanner 630, which scans the messages for inappropriate content and generates alerts that are ultimately sent to the user. Alerts are generated when the scanner matches the text in a given message string with pre-stored lexical rules supplied by rules engine 640 (the scanning and rule-matching process is discussed in greater detail in FIGS. 9-12). After alerts are generated, the messages are sent to the all-messages data cache database 645 and alerts are sent to the alert database 650, which is then accessed by web user interfaces 660 in order to forward the alerts (in notification form) to users of the present dialogue analyzer tool. Due to the high volume of users viewing alerts, an HTTP load balancer (block 670) is implemented in order to increase the scalability of the application. A number of well known methods can accomplish this goal, including the use of a round robin system or hardware load balancers. The alert notification is then sent to an electronic account associated with a monitoring user (parent or guardian).

FIG. 7 is a process flow diagram describing the process by which the threat analysis instant messaging collector gathers data. In step 700, the collector receives an incoming XML/RPC send_message request, according to the format specified in table 1.1. The collector then moves on to step 710: determining whether the message is being sent from a valid user. As previously mentioned in Table 1.1, the client_id is a 37 character globally unique identifier that associates the client to a threat analyzer service account. The client corresponding to each threat analyzer service, however, has the ability to monitor any number of screen names that are logged onto a local computer with the client installed. In step 710, the client_id of the collected message is cross-compared to a list of all known client_ids (which is stored at the threat analysis server). The client_ids on this list accrue each time a new threat analyzer service user, who wishes to monitor the online activity of anyone using its local computer(s) for electronic communications with remote computer users, signs up for an electronic account corresponding to the present threat analyzer service. If a match exists between the client_id associated with the collected message and the list of known client_ids, the process moves forward to step 730. If no match is found, the message is dropped in step 715.

In step 730, the collector determines whether the screen name associated with the account number is being monitored by the user sending the request. To execute this step, the collector checks a previously-generated table that displays all known screen names being monitored by the user account associated with the specific client. If the screen name is being monitored by such user, then this signifies that the user is monitoring the screen name and the process jumps forward to step 770. If the screen name is not monitored by the user sending the message, then step 740 is performed. Step 740 determines whether the screen name is being monitored by any known user accounts by referencing the list of all known screen names being monitored. If the screen name is not being monitored by any known user, then a screen name for a user account as parent is created in step 750. If, however, the screen name is already being monitored, then a parent account has been created and the process jumps forward to step 760, where a monitored screen name for the user account as guardian is created. This process (ie., steps 730-760) ensures that any potential alert notification that is generated based on the contents of the message is sent not only to a user currently monitoring the message, but also to any known parent account associated with the screen name being monitored. This procedure is advantageous because each user that is concerned with the local (ie., monitored) child's safety is notified when alerts are generated based on communications involving that child. For example, if a child is engaged in potentially dangerous communications with someone else on a school computer with a previously installed threat analysis client, an alert notification will be sent to the child's parent as well as the administrator of the school computer (who may be charged with the safety of that child).

The process then proceeds to step 770. In step 770, the HTML tags on the message are filtered, then all HTML entities are converted to ASCII (American standard code for information interchange) code. This collected message is then tracked in step 780. This “tracking process” involves keeping a statistical record of the screen name being monitored. These statistics are accumulated and displayed to users of the threat analyzer service in a community statistics reporting statement (shown in FIG. 2). Finally, the collected message is added to a database of raw messages (i.e., those that have not yet been processed by the collector and/or scanner) in step 790.

In an alternative embodiment, when a particular screen name has been associated with more than one client user-account (i.e., parent and guardian), an email may be sent to both client user accounts, requesting the user identify themselves and their relationship to the particular screen name. In yet another embodiment, a frequency monitor may be used in order to determine the frequency at which the screen name is using one account as compared to the other. In this situation, if it is determined that a guardian account is being used more frequently then one identified as a parent account, the designations of the accounts may be switched, with the guardian account being designated as parent and the parent being designated as guardian.

A similar process occurs with respect to notes, comments and other like communications placed on social networks. FIG. 8 displays this process. In step 805, a send_note request is received (see table 2.2). Then, in step 810, a determination is made as to whether a checksum associated with the communication (based on the information in the local_screen_name, remote_screen_name, and message fields) already exists. This step is performed because communications that occur over social networks are sometimes monitored by the client service more than once. These duplicates exist because the client copies substantially all of the data relating note postings and other communications on social networks, which usually includes previously communicated (and thus previously collected) data. Step 810 is executed by comparing the checksum to a list of all known checksums previously calculated for given screen names. If the checksum does not exist, the process proceeds to step 825. If, however, the checksum exists, the note, comment, or like communication is a duplicate. Duplicates are tracked (ie., relevant statistics recorded) in step 815 and dropped in step 820. In alternative embodiments, however, this duplicate-tracking can occur within the client.

In step 825, the collector determines whether the communication is associated with a valid user. In this process, the client_id of the collected message is cross-compared to a list of all known client_ids. If a match exists between the client_id associated with the collected communication and the list of known client_ids, the process moves forward to step 835. If no match is found, the message is dropped in step 830.

In step 835, the collector determines whether the screen name associated with the account number is being monitored by the user sending the request. To execute this step, the collector checks a previously-generated table that displays all known screen names being monitored by the user account associated with the specific client. If the screen name is being monitored by such user, then this signifies that the user is monitoring the screen name and the process jumps forward to step 855. If the screen name is not monitored by the user sending the message, then step 840 is performed. Step 840 determines whether the screen name is being monitored by any known user account by referencing the list of all known screen names being monitored. If the screen name is not being monitored by any known user, then a screen name for the user account as parent is created in step 845. If, however, the screen name is already being monitored, then a parent account has been created and the process moves forward to step 845, where a monitored screen name for the user account as guardian is created. Similar to the process relating to instant messages that occurs in FIG. 7, this process (ie., steps 835-840) ensures that any potential alert notification that is generated based on the contents of the message is sent to each user that is concerned with the local (ie., monitored) child's safety.

The process then proceeds to step 855. In step 855, the HTML tags on the message are filtered, then all HTML entities are converted to ASCII (American standard code for information interchange) code. Then, step 860 is performed, whereby the time stamp from the social network is converted to the ISO 8601 standard, the international standard for data and time representations. The signature feature of the ISO 8601 format for date and time is that the information is ordered from the most to the least significant or, in plain terms, from the largest (the year) to the smallest (the second). From here, a checksum is created from the information in the local-_screen_name, remote_screen_name, and message fields stored in send_note request. The checksum that is utilized is an MD-5 checksum, well known by those having skill in the art. The note is tracked in step 870 (statistics are recorded in order to update the community statistics report). Finally, the note is added to a database of raw messages for scanning in step 875.

FIG. 9 is a flow chart depicting the process by which the dialogue analyzer scans collected instant messages for inappropriate content. As shown in the diagram, the scanning process accomplishes three major tasks: 1) finding and preparing messages for scanning (this process is depicted in greater detail in FIG. 9A); 2) scanning messages and create alerts (depicted in FIG. 9B); and 3) writing stats, alerts, and messages (depicted in FIG. 9C).

FIG. 9A is a process flow diagram that illustrates the procedure by which messages are found and prepared for scanning. As previously discussed with respect to FIG. 7, these messages have been collected from conversations involving valid users of the threat analysis service. Initially, in step 901, conversations are found in the message processing database. These conversations include instant messages between a local monitored user and a remote participant. In step 902, the instant messages that are transmitted in a conversation between a local (dialogue analyzer monitored user) screen name and a remote screen name are gathered. This gathering process occurs until there is a break in the communication between the two parties. This break may be defined as a cessation of communication predetermined length of time (e.g., 2 hours). The position of the last message from the last conversation scanned is found in step 903. These positions are found in the alerts database, where they previously have been stored. The next step is to position all the messages in the conversation in the order of their occurrence (step 904). In an alternative embodiment, the aforementioned steps (901-904) may be performed by the client before transmitting the data to the threat analysis servers.

The process proceeds to step 905, where the messages corresponding to the local screen name are separated from those that relate to the remote screen name. This step involves separating all of the messages sent from the local screen name to the remote screen name from the messages sent from the remote screen name to the local screen name. This is done in order to determine which screen name is responsible for the transmission of inappropriate content so that the dialogue analyzer tool can include that screen name identification in an email notification of the flagged content to the parent or guardian account.

In step 906, after the messages have been separated by screen name, the scanner selects a number of messages in order to populate a window of messages. The size of the window is based on the messages transmitted in a predetermined period of time. In a preferred embodiment, the size of the window is approximately 120 seconds. This translates into a carrying capacity of roughly 10 messages and 128 characters per window.

Later in the scanning process, each individual window is analyzed for inappropriate content based on the rules stored in the threat analysis rules engine. Because multiple messages may be stored in a single window, these messages are concatenated in step 907 in order to produce windows including messages in single text-string format. At this point (step 908), the message windows have been prepared and are ready for processing.

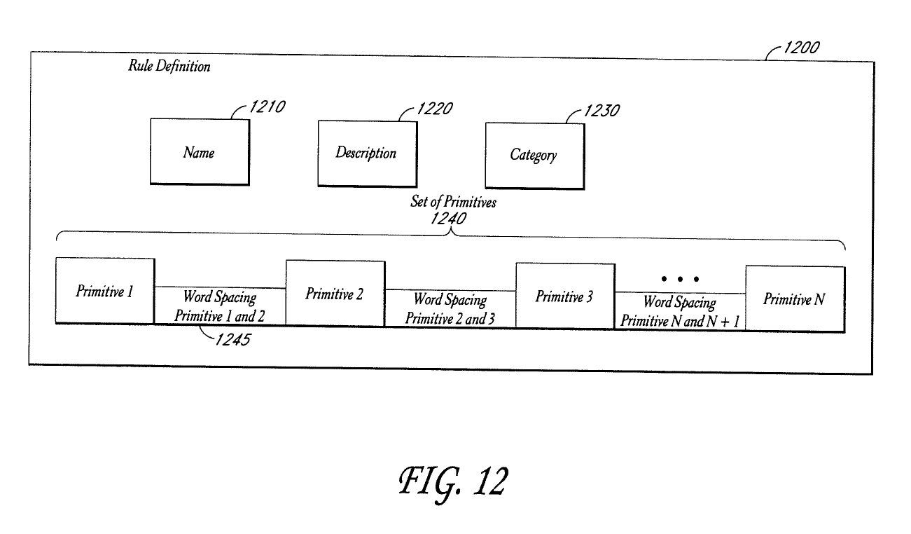

The process then proceeds to steps 930-939, where the messages are scanned and alerts are created. This is depicted in FIG. 9B. In step 930, each window is processed with each rule from the threat analysis rules engine. These rules are discussed in greater detail in the discussion of FIG. 12. Step 931 determines whether the text in the particular window matches any of the rules in the threat analysis rules engine. If not, the process proceeds to step 938. If, however, the text in the window matches a rule, then a loop is performed whereby alerts are created before proceeding to step 938. This loop begins at step 931, where an alert and copy of rules is created for each user that is monitoring the local screen name. These alerts are also described in greater detail in connection with FIG. 12.

After the alerts are created based on the inappropriate content, several mini-loops are performed in order to determine whether messages from previous and/or future windows should be added to the messages containing the alert(s) in the current window. This process is performed in order to ensure that the inappropriate content is forwarded to the user with enough communication before and/or after the content to give the reader some context of the inappropriate behavior within the overall conversation between two screen names. In the preferred embodiment, 12-14 lines of text from an IM conversation are forwarded to a parent user in an alert notification. This will present some context to the inappropriate content detected, but also ensure the privacy of the non-dangerous communications that the local screen name takes part in. To accomplish this goal, step 933 determines whether the next window of messages should be added to the current window with the alert(s). This situation is referred to herein as a “hang over” and occurs when the first message in a given window contains an alert. If there is a hang over, then a mini-loop is performed to step 937, where additional messages from the all-messages cache database are flagged to added to the beginning of the message containing the alert inside the current window.

After step 937 is performed, or if no hang overs existed, the process proceeds to step 934, where a determination is made of whether the last message in the window contains the alert. This situation is referred to herein as a “hang under.” If a hang under exists, then a mini-loop to step 936 is performed, whereby a record can be created with message positions needed from the next scan. After this process is performed, or if no hang unders existed, the process moves forward to step 935, where the massages from the window containing the alert are flagged to be written to the alerts database. After this loop is performed, the process moves forward to step 938. In this step, the scanner determines whether there is a previous hang under by analyzing the record created from a previous scan in step 936. If the record indicates that there was a previous hang under, then additional messages from the window are flagged to be written to the alerts database.

After this step is performed (or if the performance of step 938 leads to a determination that there were no previous hang unders), the process then proceeds to steps 960-963, in which alerts and messages are written for the user interface to the alerts database. This process is illustrated in FIG. 9C. In step 960, messages that have been flagged are removed from the raw messages database and written to the all messages cache database in step 961. The next step (962) involves writing the alert(s), rules and messages for the user interface to the alerts database. Samples of email notifications that include these alerts, rules and messages are illustrated in FIGS. 3 and 4. Finally, the conversation positions and stats for each screen name in the analyzed conversation are updated in step 963.

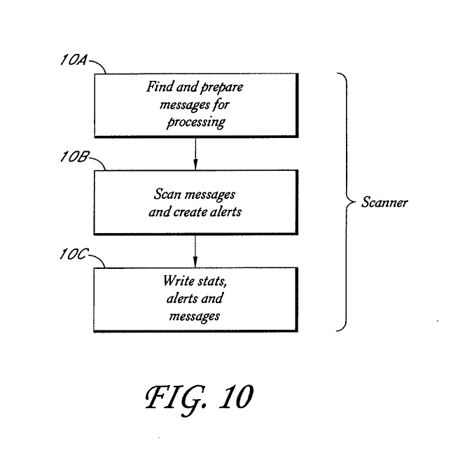

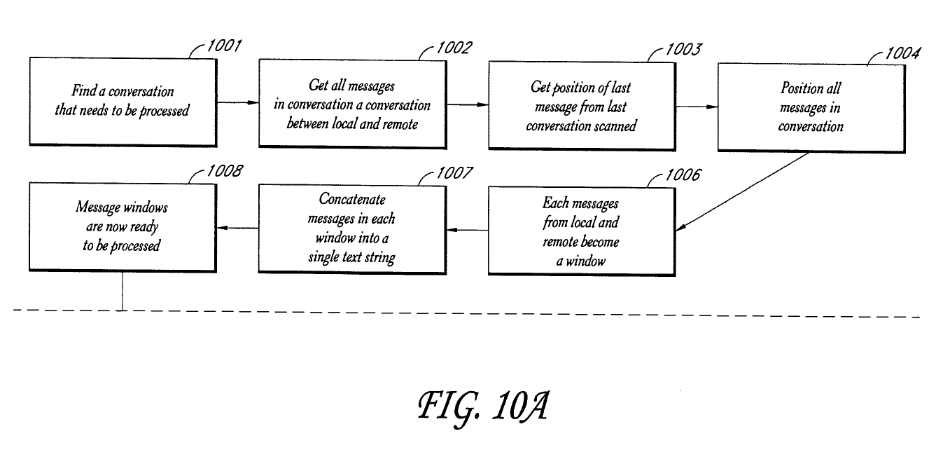

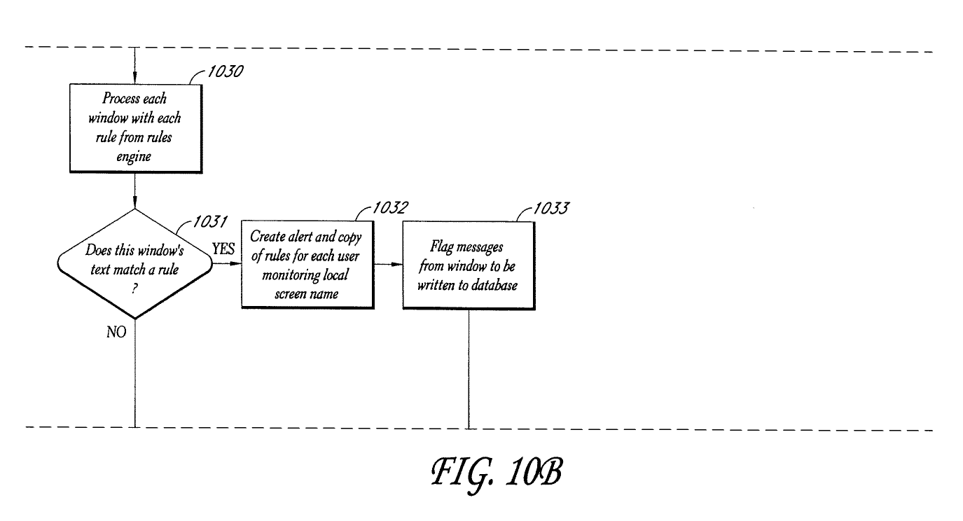

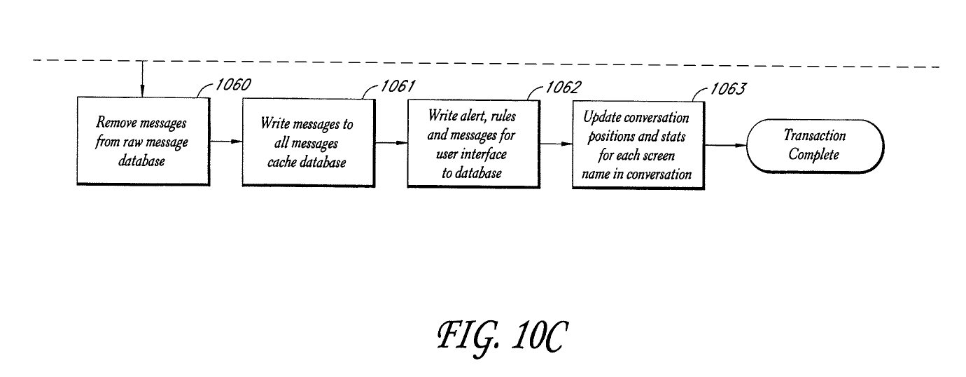

FIG. 10 is a flow chart of the scanning process for scanning notes or comments on social networks (like Facebook, Myspace®, etc.). This process is similar to that described in FIG. 9 with respect to scanned instant messages, but includes a few minor modifications based upon the fact that an instant message is a two-way conversation between a remote and local screen names, while a note placed on a social networking website is more akin to just one side of a conversation taking place.

FIG. 10A illustrates steps 1001-1008, in which messages are found and prepared for processing. As previously discussed in connection to FIG. 8, these messages have been collected from conversations involving users with valid accounts. Initially, in step 1001, conversations are found. Conversations include the transmission of instant messages to and from a local user and a remote screen name. In step 1002, all of the instant messages that are transmitted in a conversation between a local and remote screen name are gathered. This gathering process occurs until there is a break in the communication between the two parties based upon a predetermined length of time (e.g., 2 hours). The position of the last message from the last conversation scanned is found in step 1003. The next step (1004) is to position all the messages in the conversation in the order of their occurrence. These steps (ie., 1001-1004) also may be performed by the client prior to transmission of the data to the threat analysis servers.

In step 1006, after the messages have been separated by screen name, each message is placed in its own window of data. These messages are concatenated in step 1007 in order to produce windows including messages in single text-string format. At this point, the message windows have been prepared and are ready for processing (step 1008).

The process then proceeds to steps 1030-1033, depicted in FIG. 10B. In this process, each text window is scanned and alerts are created. Step 1031 determines whether the text in the particular window matches any of the rules in the threat analysis server rules engine. If not, the process proceeds to step 1060. If, however, the text in the window matches a rule, then a loop is performed whereby alerts are created. This loop begins at step 1032, where an alert and copy of rules is created for each user that is monitoring a local screen name. Further detail regarding rules and alerts is given in FIGS. 10-13 and the discussion thereof. In step 1033, the messages from the text window are flagged to be written to the alerts database.

After this step is performed (or if the performance of step 1031 leads to a determination that the window text did not match any rule in the threat analysis rules engine), the process proceeds to step 1060. In this step, messages that have been processed and then scanned are removed from the raw messages database and written to the all messages cache database in step 1061. The next step, 1062, involves writing the alert(s), rules and flagged messages for the user interface to the alerts database. Samples of email notifications that include these alerts, rules and messages are illustrated in FIGS. 3 and 4. Finally, the conversation positions and stats for each screen name in the analyzed conversation are updated in step 1063.

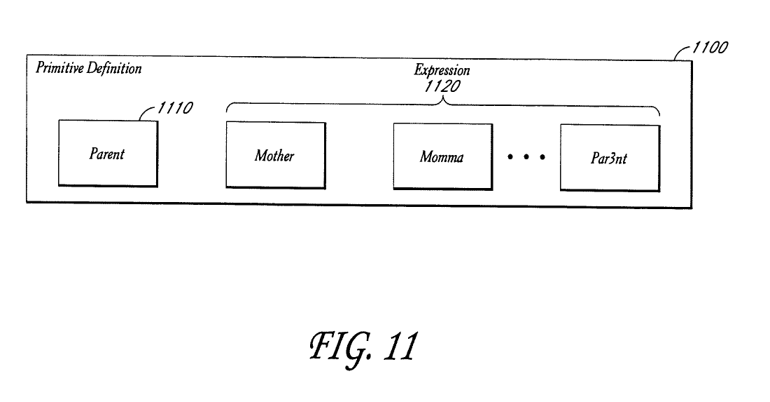

FIG. 11 is an overview of the threat analysis rules engine according to one embodiment of the present disclosure. This rules engine provides the bases for determining whether a particular message contains inappropriate content. It also provides the protocol by which to alert a parent account of the inappropriate activity. The rules in the engine are based on language concepts that are referred to herein as “primitives.”

FIG. 11 provides the basic definition of a primitive 1100. A primitive is essentially a word concept that comprises many words that are associated by having a similar sound, meaning, use, spelling, appearance or (probability of appearance in a text string), etc. Primitives can include people, places, pronouns, verbs, adverbs, adjectives, activities, or any other lexical unit. As shown in FIG. 11, a primitive has a root in a specific word 1110, like “parent.” Primitive expression 1120 includes any number of words that can be used in everyday parlance as a substitute for the primitive or have a similar meaning as that word. For example, the expression of the word “parent” includes of a number of associated words (i.e., other words having a similar sound, meaning, usage, spelling, appearance, etc.), such as mother, momma, dad, father, stepmom, stepdad, pairent, par3nt, etc. Thus, the threat analysis rules engine understands not only proper English, but common misspellings, slang and even leet speak (where alphanumerics are interchanged with letters). In this regard, primitives are used as a way in which to normalize text data collected during online communication monitoring. Another example of a primitive is the word “home,” which can have several words associated with it, such as h0me, crib, pad, hom, place, etc. Yet another example of a primitive is the word “sex,” which could also have several associated words like coitus, lovemaking, intimacy, s3x, secks, etc. These like or associated words and word concepts are matched to those used in message text-strings by fuzzy matching using any one of various well known methods. In the preferred embodiment, the fuzzy matching is implemented by regular expressions (i.e., strings used to describe or match a set of strings according to certain syntax rules). In an alternative embodiment, the words can be matched by a direct comparison to libraries of words or word concepts corresponding to a particular primitive.

In a preferred embodiment, the expressions of primitives are machine-formatted patterns that represent words that administrators of the dialogue analyzer service wish to flag when used during electronic communications. These patterns are implemented as regular expressions, but any technology that allows for the matching and representation of patterns may be implemented. In another embodiment, the root word can be processed by an algorithm that generates like words through the use of a thesaurus, dictionary, or a catalogue of misspellings and axioms of leet speak or common instant messaging language.

The threat analysis rules are defined by situations where multiple primitives are found together in a text string. FIG. 12 provides the basic definition of a rule in the rules engine. A rule is defined by a text string including one or more primitives with a certain number of non-primitive words in between the primitives (if there are multiple primitives). Each rule has a name (1210), description (1220) and category (1230) classification. The name 1210 classification is a substantially unique identifier of a rule. It can include a word, a number, a combination of both, or a like identifier. Description 1220 is a brief summarization of the intended subject matter associated with the rule, such as “asking for phone number” or “sexually explicit communication.” Category 1230 is a broad classification of a group in which the particular rule is logically a part. Category classifications can include “lewd,” “offensive,” “threatening,” “direct contact,” “indirect contact,”, “sexual act,” etc.

As shown in the figure, any number of primitives can exist in a set of primitives 1240 (i.e., from 1 to N, N being defined as any number). A rule is matched when these primitives are detected with a finite number (e.g., 6 or less) of non-primitive words 1245 in between them in any given text window. Matching is executed by implementation of regular expressions to identify any text that closely corresponds to the definition of a rule. In a preferred embodiment, the number of words spaced in between each primitive is 6 or less in order to decrease the probability of a detection of a rule match when the phrase is not reasonably inappropriate. The following example is both illustrative and simple: the text string “R ur par3nts gonna be h0me?” will set off a rule match because, as previously explained, the words “parents” and “h0me” are included in the expressions of primitives based on the words parents and home, respectively. Also, there are a finite number (i.e., 2) of words in between the two identified primitives. Thus example matches the rule definition. The number of words spaced in between each primitive can also be variable based upon the particular primitive.

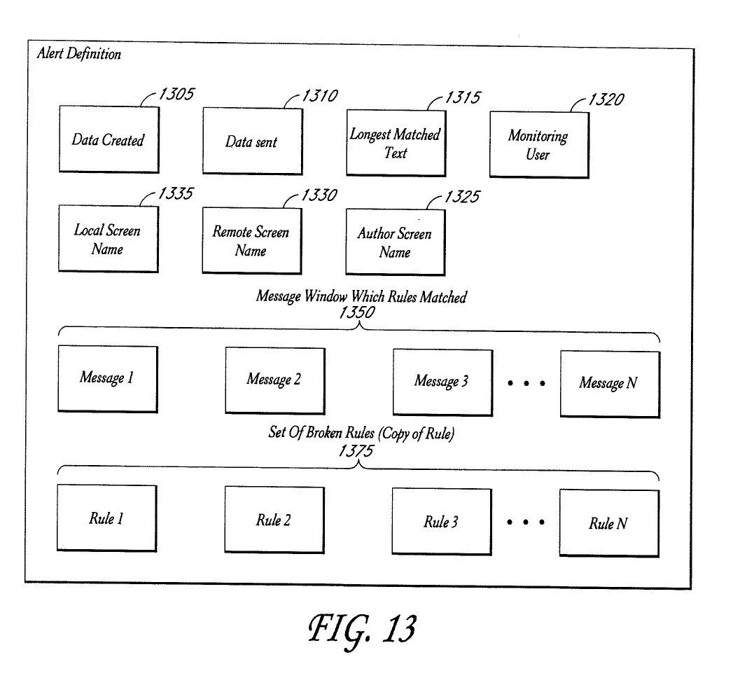

FIG. 13 provides the basic definition for alerts generated by the dialogue analyzer tool. As previously mentioned, these alerts are generated whenever text inside a window is found to have matched a rule in the threat analysis rules engine. Alerts are comprised of various fields of information that have been collected by the client and processed and stored by the methods described in FIGS. 7-10. In the preferred embodiment, these fields include Date Created 1305, Date Sent 1310, Longest Matched Text 1315, Monitoring User 1320, Local Screen Name (ie., monitored) 1335, Remote Screen Name 1330, Author (of message) Screen Name 1325, Message Window 1350 and Rules Set 1375. Date Created 1305 corresponds to the date the message was created, while Date Sent 1310 corresponds to the date the alert was sent to the user. Longest matched text 1315 includes a copy of the longest string of text that matched one of the rules in the rules engine. Monitoring User 1320 is an identification of the user name of the logged-in operating system user on the computer with the dialogue analyzer client software.

Message window 1350 contains the messages from the text window that included a rule-matching message. As described earlier, the window is designed to capture approximately 2 minutes of text in a conversation. Thus, the window can contain any number of messages (from 1 to n) based on length of the individual messages. Rules Set 1375 is a collection of copies of the rules that were matched by any set of the message data in message window 1350. In a preferred embodiment, rules are updated and revised frequently, thus it is desirable to create and store copies of rules in Rules Set 1375 in order to have the ability to reference them in the future.

In an alternative embodiment, alerts can be generated based on a traditional Bayesian analysis of the probability that a text string will include certain predetermined words or subject matter. This alternative can be effectively implemented once a sufficient corpus of alerts has been created. Other alternatives for identifying a specific subject matter (e.g., predatory behavior) in text-based communications include strict keyword matching, phonetic matching, grammar checks, and the like.

Those of skill will further appreciate that the various illustrative logical blocks, modules, components, and process steps described in connection with the embodiments disclosed herein may be implemented as electronic hardware, computer software, or combinations of both. To clearly illustrate this interchangeability of hardware and software, various illustrative components, blocks, components, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosures.

In addition, while certain embodiments of the disclosures have been described, these embodiments have been presented by way of example only, and are not intended to limit the scope of the disclosures. Indeed, the novel methods and systems described herein may be embodied in a variety of other forms; furthermore, various omissions, substitutions, and changes in the form of the methods and systems described herein may be made without departing from the spirit of the disclosures. The accompanying claims and their equivalents are intended to cover such forms or modifications as would fall within the scope and spirit of the disclosures.

Although the foregoing disclosure has been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. Accordingly, the present disclosure is not intended to be limited by the reaction of the preferred embodiments, but is to be defined by reference to the appended claims.

Additionally, all publications, patents, and patent applications mentioned in this specification are herein incorporated by reference to the same extent as if each individual publication, patent, or patent application was specifically and individually indicated to be incorporated by reference.

1. A method of alerting a parent or guardian of a minor or other computer user identified interactions occur on a computing device used by said minor or other computer user relating to said minor or other computer user, the method comprising:
receiving information from a monitored computer, said information including data indicative of communication or activity between a user of said monitored computer and one or more remote users, said communication or activity occurring electronically within at least one of a chat room environment, an instant messaging environment, a social networking environment, an electronic gaming environment, an electronic dating environment or an online service configured to cause interaction between users thereof;
identifying said data based at least on scanning said data for matches to predetermined lexical rules, wherein a rule of said lexical rules is matched when primitives are detected with a finite number of non-primitive words between them; and
outputting a report to said parent or guardian when said data is identified, said report including at least an explanation of said identified activity.

2. (canceled)

3. (canceled)

4. The method of claim 1, wherein said report comprises an electronic communication to said parent or guardian.

5. The method of claim 4, wherein said communication includes contextual information surrounding said identified activity but does not include an entire interaction.

6. The method of claim 1, wherein said lexical rules comprise one or more word-concept combinations.

7. The method of claim 6, wherein said one or more word-concept combinations comprise alphanumerics associated by sharing at least one of the following similarities: sound, meaning, usage, spelling, or appearance.

8. The method of claim 6, wherein said one or more word-concept combinations comprise machine-formatted patterns that represent words.

9. An alert system for providing a monitoring user information about identified activities of a monitored user, the alert system comprising:
a rules engine;
a client service receiving alphanumeric information communicated to or from a monitored electronic device used by said monitored user, said alphanumeric information being identified through said rules engine configured to evaluate incoming alphanumeric information from said monitored electronic device using a set of predetermined lexical rules, wherein a rule of said lexical rules is matched when primitives are detected with a finite number of non-primitive words between them; and
a monitoring-user computer for outputting contextual information comprising communications occurring around said alphanumeric information, wherein said contextual information includes less than an entirety of activity of the monitored user, and for outputting summary information interpreting the alphanumeric information for the monitoring user.

10. The alert system of claim 9, comprising an identification of the service provider that facilitated said communications.

11. The alert system of claim 9, wherein said summary information includes a human-readable explanation of why said alphanumeric information was identified.

12. The alert system of claim 9, comprising a date and/or time said alphanumeric information was communicated to or from said monitored electronic device.

13. The alert system of claim 9, wherein at least a portion of the identified alphanumeric information is highlighted for emphasis.

14. The alert system of claim 9, wherein said lexical rules comprise one or more word-concept combinations.

15. The alert system of claim 14, wherein said word-concept combinations comprise alphanumerics associated by sharing at least one of the following similarities: sound, meaning, usage, spelling, or appearance.

16. The alert system of claim 14, wherein said word-concept combinations comprise machine-formatted patterns that represent words.
